(19) United States
(12) Patent Application Publication
(10) Pub. No.: US 2011/0301757 A1
(43) Pub. Date: Dec. 8, 2011

(54) ADAPTABLE CONTAINER HANDLING ROBOT WITH BOUNDARY SENSING SUBSYSTEM

(75) Inventors: Joseph L. Jones, Acton, MA (US); Todd Comins, Chelmsford, MA (US); Clara Vu, Cambridge, MA (US); Michael Bush, Arlington, MA (US); Larry Gray, Merrimack, NH (US); Charles M. Grinnell, Groton, MA (US)

(73) Assignee: Harvest Automation, Inc., Billerica, MA (US)

(21) Appl. No.: 13/100,763

(22) Filed: May 4, 2011

Related U.S. Application Data
(63) Continuation-in-part of application No. 12/378,612, filed on Feb. 18, 2009.
(60) Provisional application No. 61/066,768, filed on Feb. 21, 2008.

(51) Int. Cl. B25J 13/08

(52) U.S. Cl. 700/258

(57) ABSTRACT

An adaptable container handling robot includes a chassis, a container transport mechanism, a drive subsystem for maneuvering the chassis, a boundary sensing subsystem configured to reduce adverse effects of outdoor deployment, and a controller subsystem responsive to the boundary sensing subsystem. The controller subsystem is configured to detect a boundary, control the drive subsystem to turn in a given direction to align the robot with the boundary, and control the drive subsystem to follow the boundary.

### RELATED APPLICATIONS

This application is a continuation-in-part of prior U.S. patent application Ser. No. 12/378,612 filed Feb. 18, 2009, which claims the benefit of and priority to U.S. Provisional Patent Application Ser. No. 61/066,768, filed on Feb. 21, 2008; each said application incorporated herein by this reference.

### BACKGROUND

The present application relates generally to nursery and greenhouse operations and, more particularly, to an adaptable container handling system including one or more robots for picking up and transporting containers such as plant containers to specified locations.

Nurseries and greenhouses regularly employ workers to reposition plants such as shrubs and trees in containers on plots of land as large as thirty acres or more. Numerous, e.g., hundreds or even thousands of containers may be brought to a field and then manually placed in rows at a designated spacing. Periodically, the containers are re-spaced, typically as the plants grow. Other operations include jamming, (e.g., for plant retrieval in the fall), consolidation, and collection.

The use of manual labor to accomplish these tasks is both costly and time consuming. Attempts at automating such container handling tasks have met with limited success.

### BRIEF SUMMARY OF THE DISCLOSURE

An adaptable container handling robot in accordance with one or more embodiments includes a chassis, a container transport mechanism, a drive subsystem for maneuvering the chassis, a boundary sensing subsystem configured to reduce adverse effects of outdoor deployment, and a controller subsystem responsive to the boundary sensing subsystem. The controller subsystem is configured to detect a boundary, control the drive subsystem to turn in a given direction to align the robot with the boundary, and control the drive subsystem to follow the boundary.

A method of operating an adaptable container handling robot in an outdoor environment in accordance with one or more embodiments includes providing a boundary outside on the ground, and maneuvering a robot equipped with a boundary sensing subsystem to: detect the boundary, turn in a given direction to align the robot with the boundary, and follow the boundary. The robot is operated to reduce adverse effects of outdoor boundary sensing and following.

### BRIEF DESCRIPTION OF THE DRAWINGS

FIG. 1 is a schematic aerial view of an exemplary nursery operation;

FIG. 2 is a highly schematic three-dimensional top view showing several robots in accordance with one or more embodiments repositioning plant containers in a field;

FIG. 3 is a block diagram depicting the primary subsystems associated with a container handling robot in accordance with one or more embodiments;

FIGS. 4A-4B (collectively FIG. 4) are front perspective views showing an example of one container handling robot design in accordance with one or more embodiments;

FIGS. 5A-5B (collectively FIG. 5) are perspective and side views, respectively, showing the primary components associated with the container lift mechanism of the robot shown in FIG. 4;

FIGS. 6A-6D (collectively FIG. 6) are highly schematic depictions illustrating container placement processes carried out by the controller of the robot shown in FIGS. 3 and 4 in accordance with one or more embodiments;

FIGS. 7A-7D (collectively FIG. 7) are perspective views illustrating four different exemplary tasks that can be carried out by the robots in accordance with one or more embodiments;

FIG. 8 is a front view showing one example of a user interface for the robot depicted in FIGS. 3 and 4;

FIG. 9 is a schematic view depicting how a robot is controlled to properly space containers in a field in accordance with one or more embodiments;

FIG. 10 is a simplified flow chart depicting the primary steps associated with an algorithm for picking up containers in accordance with one or more embodiments;

FIGS. 11A-D (collectively FIG. 11) are views of a robot maneuvering to pick up a container according to the algorithm depicted in FIG. 10;

FIG. 12 is a simplified block diagram depicting the primary subsystems associated with precision container placement techniques in accordance with one or more embodiments;

FIG. 13 is a front perspective view of a robot in accordance with one or more embodiments configured to transport two containers;

FIG. 14A is a front perspective view of a container handling robot in accordance with one or more embodiments;

FIG. 14B is a front view of the robot shown in FIG. 14A;

FIG. 14C is a side view of the robot shown in FIG. 14A;

(FIGS. 14A-14c are Collectively Referred to as FIG. 14)

FIG. 15 is a schematic view showing an example of boundary sensing module components in accordance with one or more embodiments;

FIG. 16 is a circuit diagram depicting a method of addressing the effect of sunlight when the sensor module of FIG. 15 is used in accordance with one or more embodiments;

FIG. 17 is a schematic view showing an example of a shadow wall useful for the sensing module of FIG. 15 in accordance with one or more embodiments; and

FIG. 18 is a schematic front view showing another version of a shadow wall in accordance with one or more embodiments.

FIG. 19 is a schematic view of an example of a mask structure useful for the sensing module of FIG. 15 in accordance with one or more embodiments;

FIGS. 20a and 20b are schematic views illustrating operation of a sensing module utilizing a shadow wall in accordance with one or more embodiments; and

FIG. 21 schematically illustrates a robot following a curved boundary marker in accordance with one or more embodiments.

### DETAILED DESCRIPTION OF THE INVENTION

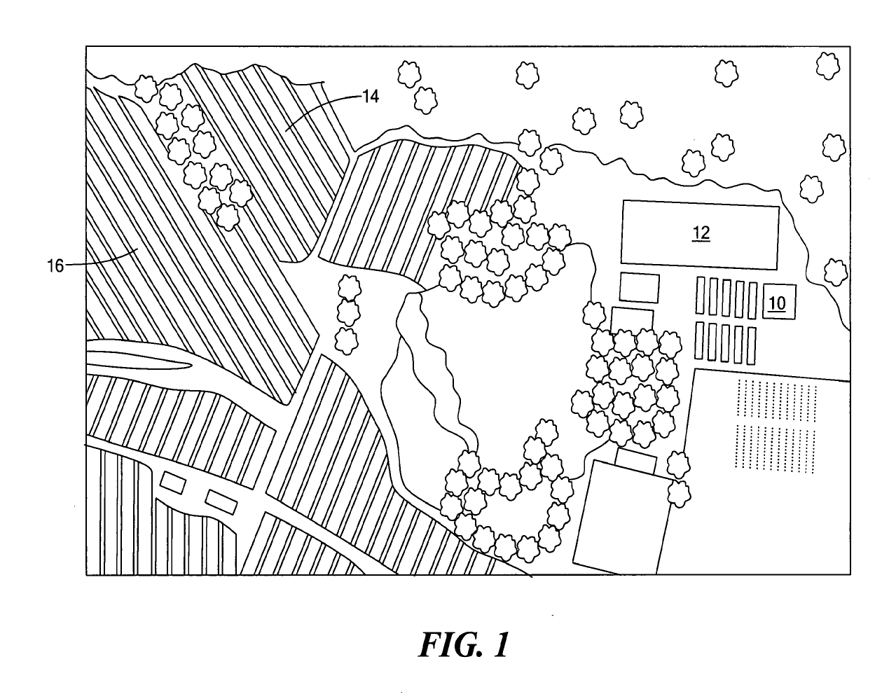

FIG. 1 shows an exemplary container farm where seedlings are placed in containers in building 10. Later, the plants are moved to greenhouse 12 and then, during the growing season, to fields 14, 16 and the like where the containers are spaced in rows. Later, as the plants grow, the containers may be repositioned (re-spacing). At the end of the growing season, the containers may be brought back into greenhouse 12 and/or the plants sold. The use of manual labor to accomplish these tasks is both costly and time consuming. Attempts at automating these tasks have been met with limited success.

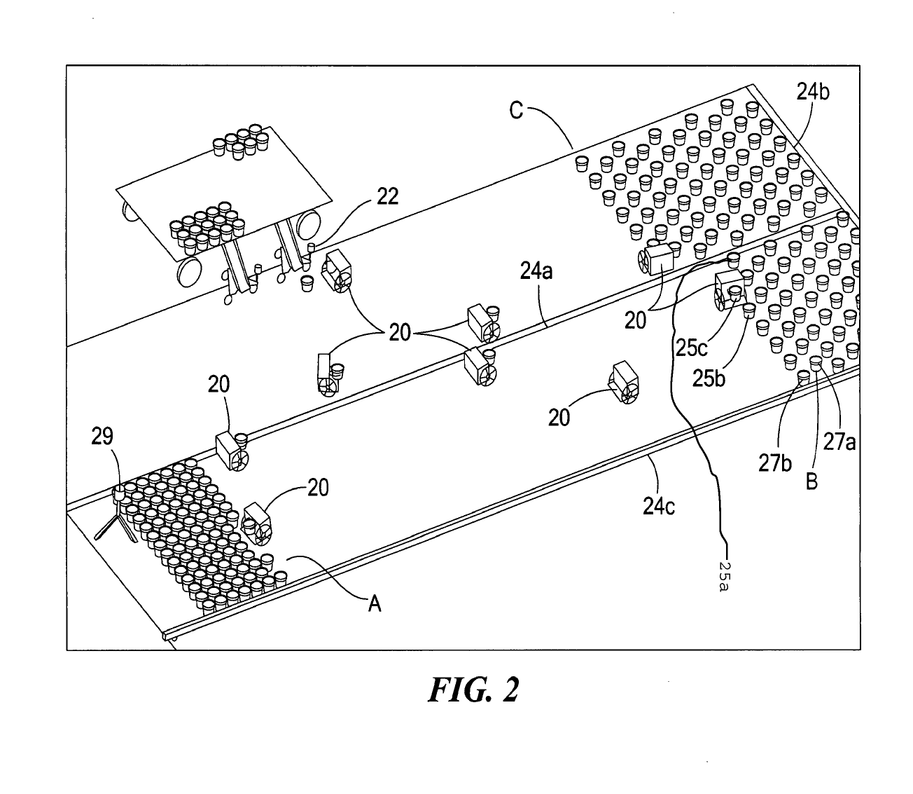

FIG. 2 illustrates exemplary operation of autonomous robots 20, FIG. 2 in accordance with one or more embodiments to transport plant containers from location A where the containers are “jammed” to location B where the containers are spaced apart in rows as shown. Similarly, robots 20 can retrieve containers from offloading mechanism 22 and space the containers apart in rows as shown at location C. Boundary marker 24a, in one example, denotes the separation between two adjacent plots where containers are to be placed. Boundary marker 24b denotes the first row of each plot. Boundary marker 24c may denote the other side of a plot. Or, the plot width is an input to the robot. In one embodiment, the boundary markers include retro-reflective tape or rope laid on the ground. The reflective tape could include non-reflective portions denoting distance and the robots could thereby keep track of the distance they have traveled. Other markings can be included in the boundary tape. Natural boundary markers may also be used since many growing operations often include boards, railroad ties, and other obstacles denoting the extent of each plot and/or plot borders. Typically, at least main boundary 24a is a part of the system and is a length of retro-reflective tape. Other boundary systems can include magnetic strips, visible non-retro-reflective tape, a signal emitting wire, passive RFID modules, and the like.

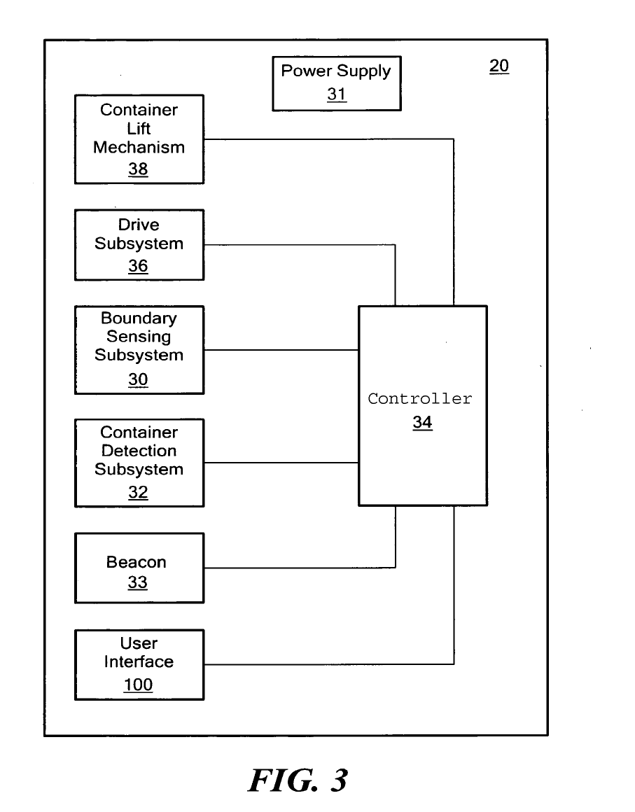

Each robot 20, FIG. 3 typically includes a boundary sensing subsystem 30 for detecting the boundaries and container detection subsystem 32, which typically detects containers ready for transport, already placed in a given plot, and being carried by the robot.

Electronic controller 34 is responsive to the outputs of both boundary sensing subsystem 30 and container detection subsystem 32 and is configured to control robot drive subsystem 36 and container lift mechanism 38 based on certain robot behaviors as explained below. Controller 34 is also responsive to user interface 100. The controller typically includes one or more microprocessors or equivalent programmed as discussed below. The power supply 31 for all the subsystems typically includes one or more rechargeable batteries, which can be located in the rear of the robot.

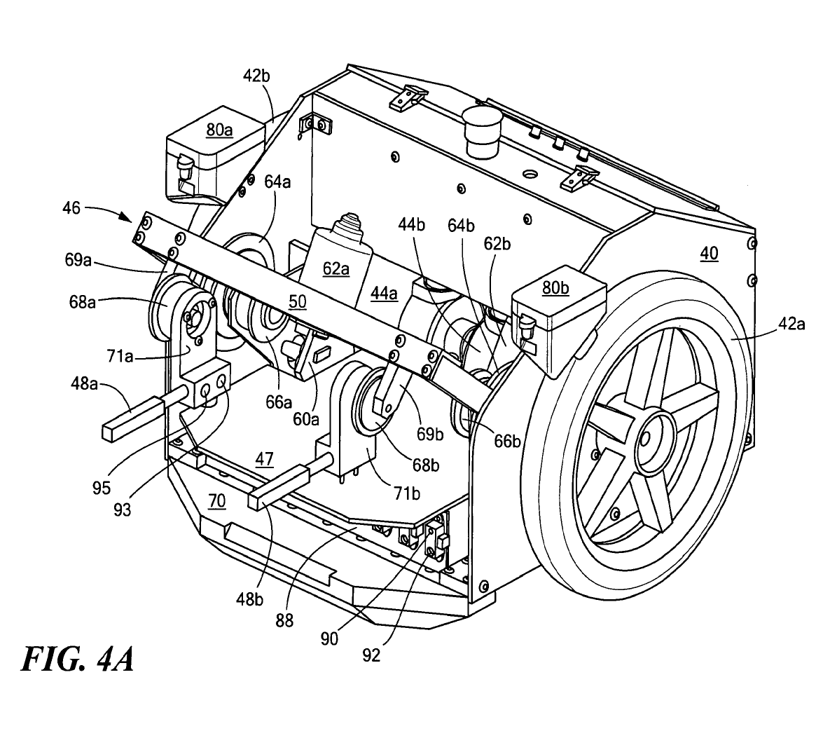

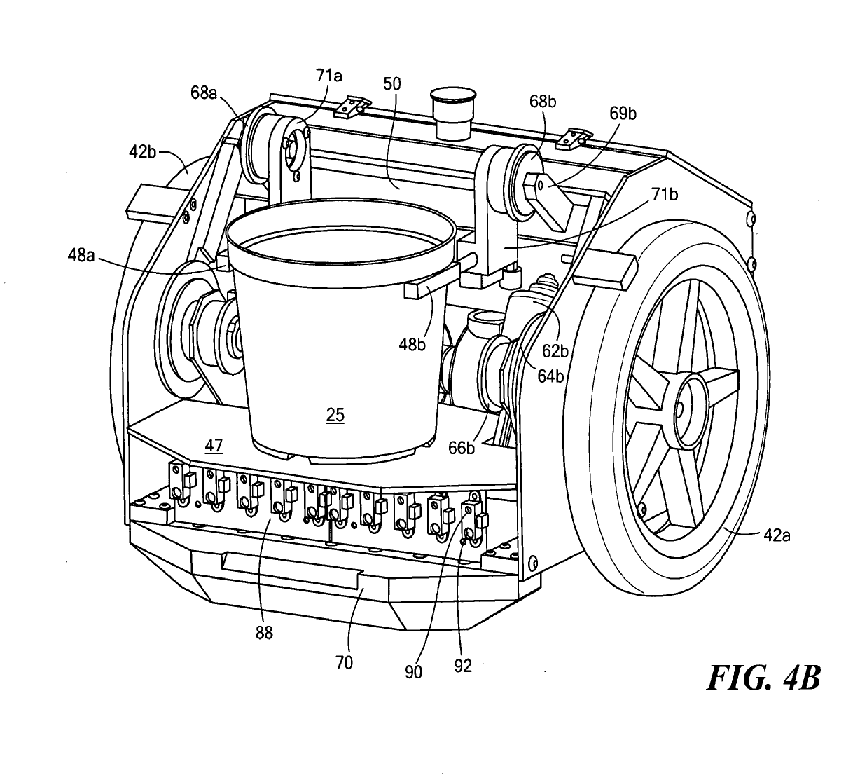

In one particular example, robot 20, FIGS. 4A-4B includes chassis 40 with opposing side wheels 42a and 42b driven together or independently by two motors 44a and 44b and a drive train, not shown. Yoke 46 is rotatable with respect to chassis 40. Spaced forks 48a and 48b extend from yoke 46 and are configured to grasp a container. The spacing between forks 48a and 48b can be manually adjusted to accommodate containers of different diameters. In other examples, yoke 46 can accommodate two or even more containers at a time. Container shelf 47 is located beneath the container lifting forks to support the container during transport.

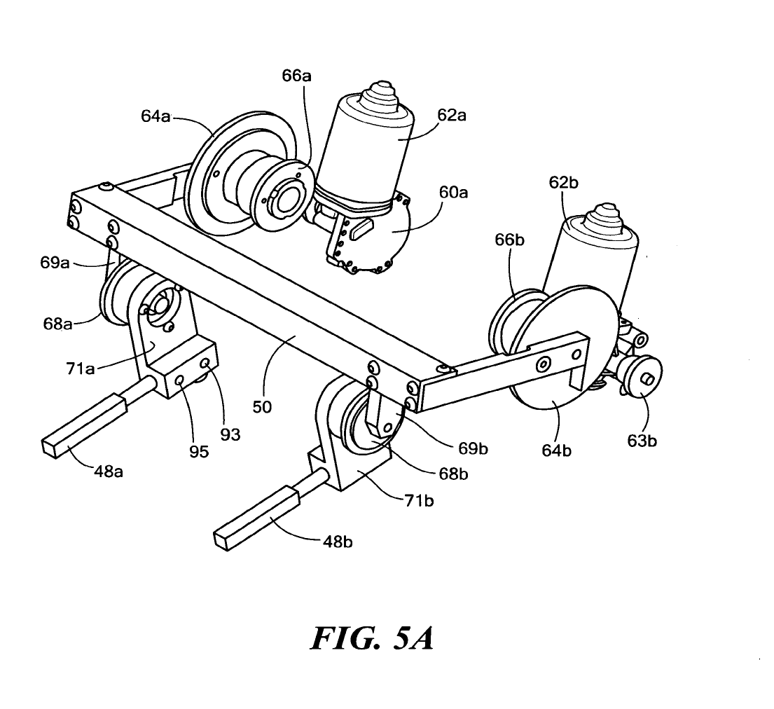

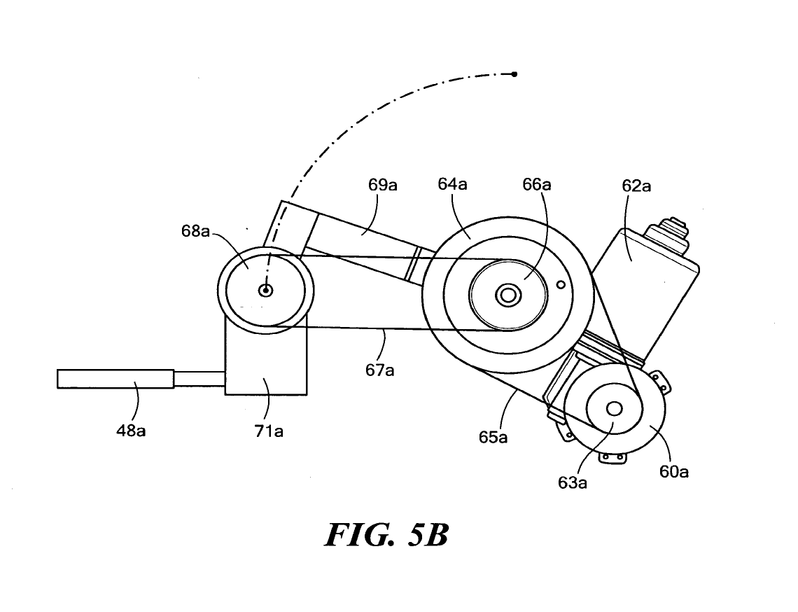

A drive train is employed to rotate yoke 46, FIGS. 5A-5B. As best shown in FIG. 5B, gearbox 60a is driven by motor 62a. Driver sprocket 63a is attached to the output shaft of gearbox 60a and drives large sprocket 64a via belt or chain 65a. Large sprocket 64a is fixed to but rotates with respect to the robot chassis. Sprocket 66a rotates with sprocket 64a and, via belt or chain 67a, drives sprocket 68a rotatably disposed on yoke link 69a interconnecting sprockets 64a and 68a. Container fork 48a extends from link 71a attached to sprocket 68a. FIGS. 4A, 4B, and 5A show that a similar drive train exists on the other side of the yoke. The result is a yoke which, depending on which direction motors 62a and 62b turn, extends and is lowered to retrieve a container on the ground and then raises and retracts to lift the container all the while keeping forks 48a and 48b and a container located therebetween generally horizontal.

FIGS. 4A-4B also show forward skid plate 70 typically made of plastic (e.g., UHMW PE) to assist in supporting the chassis. Boundary sensor modules 80a and 80b each include an infrared emitter and infrared detector pair or multiple emitters and detectors, which can be arranged in arrays. The container detection subsystem in this example includes linear array 88 of alternating infrared emitter and detection pairs, e.g., emitter 90 and detector 92. This subsystem is used to detect containers already placed to maneuver the robot accordingly to place a carried container properly. This subsystem is also used to maneuver the robot to retriever a container for replacement. The container detection subsystem typically also includes an infrared emitter detector pair 93 and 95 associated with fork 48a aimed at the other fork which includes reflective tape. A container located between the forks breaks the beam. In this way, controller 34 is informed whether or not a container is located between the forks. Other detection techniques may also be used. Thus, container detection subsystem 32, FIG. 3 may include a subsystem for determining if a container is located between forks 48a and 48b, FIGS. 4-5. Controller 34, FIG. 3 is responsive to the output of this subsystem and may control drive subsystem 36, FIG. 3 according to one of several programmed behaviors. In one example, the robot returns to the general location of beacon transmitter 29, FIG. 2 and attempts to retrieve another container. If the robot attempts to retrieve a container there but is unsuccessful, the robot may simply stop operating. In any case, the system helps ensure that if a container is present between forks 48a and 48b, FIG. 4, controller 34 does not control the robot in a way that another container is attempted to be retrieved.

In one preferred embodiment, controller 34, FIG. 3 is configured, (e.g., programmed) to include logic that functions as follows. Controller 34 is responsive to the output of boundary sensing subsystem 30 and the output of container detection subsystem 32. Controller 34 controls drive subsystem 36, (e.g., a motor 44, FIG. 4 for each wheel) to follow a boundary (e.g., boundary 24a, FIG. 2) once intercepted until a container is detected (e.g., container 25a, FIG. 2 in row 27a). Controller 34, FIG. 3 then commands drive subsystem 36 to turn to the right, in this example, and maneuver in a row (e.g., row 27b, FIG. 2) until a container in that row is detected (e.g., container 25b, FIG. 2). Based on a prescribed container spacing criteria (set via user interface 100 FIG. 3, for example), the robot then maneuvers and controller 34 commands lift mechanism 38, FIG. 3 to place container 25c (the present container carried by the robot) in row 27b, FIG. 2 proximate container 25b.

Controller 34, FIG. 3 then controls drive subsystem 36 to maneuver the robot to a prescribed container source location (e.g., location A, FIG. 2). The system may include radio frequency or other (e.g., infrared) beacon transmitter 29 in which case robot 20, FIG. 3 would include a receiver 33 to assist robot 20 and returning to the container source location (may be based on signal strength). Dead reckoning, boundary following, and other techniques may be used to assist the robot in returning to the source of the containers. Also, if the robot includes a camera, the source of containers could be marked with a sign recognizable by the camera to denote the source of containers.

Once positioned at the container source location, controller 34 controls drive subsystem 36 and lift mechanism 38 to retrieve another container as shown in FIG. 2.

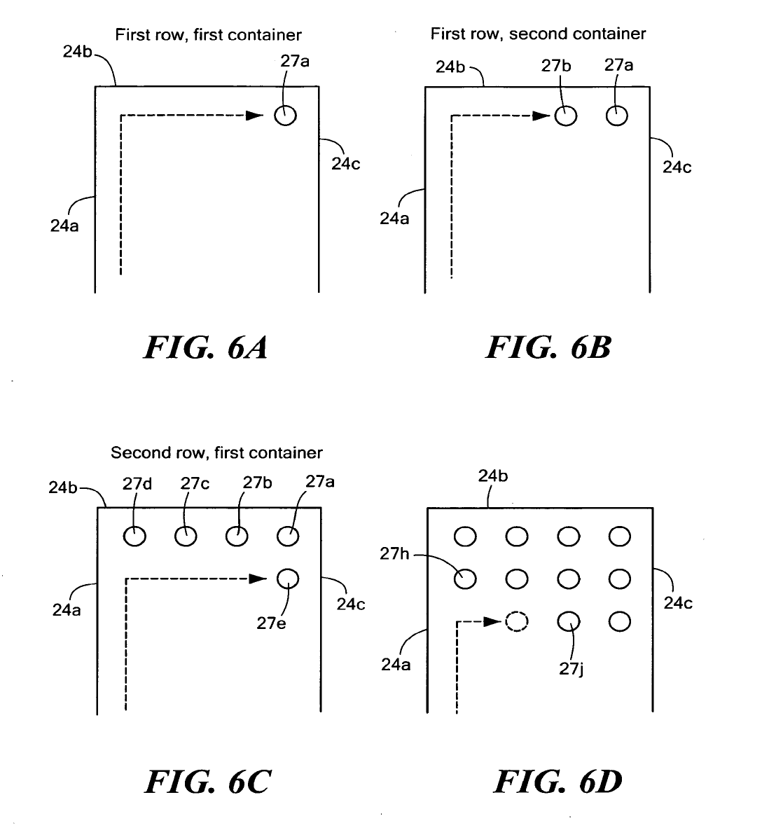

FIG. 6 depicts additional possible programming associated with controller 34, FIG. 3. FIG. 6A shows how a robot is able to place the first container 27a in the first row in a given plot. Here, no containers are detected and the robot follows boundaries 24a and 24b. In this case, when boundary 24c is detected, controller 34, FIG. 3 commands the robot to place container 27a proximate boundary 24c in the first row. Note that boundaries 24a through 24c may be reflective tape as described above and/or obstructions typically associated with plots at the nursery site. Any boundary could also be virtual, (e.g., a programmed distance). In FIG. 6B, the robot follows boundary 24a and arrives at boundary 24b and detects no container. In response, controller 34, FIG. 3 commands the robot to follow boundary 24b until container 27a is detected. The container carried by the robot, in this case, container 27b, is then deposited as shown. In a similar fashion, the first row is filled with containers 27a-27d as shown in FIG. 6C. To place the first container in second row, container 27e, the container 27d in the first row is detected before boundary 24b is detected and the robot turns in the second row but detects boundary 24c before detecting a container in that row. In response, controller 34, FIG. 3 commands the robot to maneuver and place container 27e, FIG. 6C in the second row proximate boundary 24c.

Thereafter, the remaining rows are filled with properly spaced containers as shown in FIG. 6D and as explained above with reference to FIG. 2. FIG. 6 shows the robot turning 90° but the robot could be commanded to turn at the other angles to create other container patterns. Other condition/response algorithms are also possible.

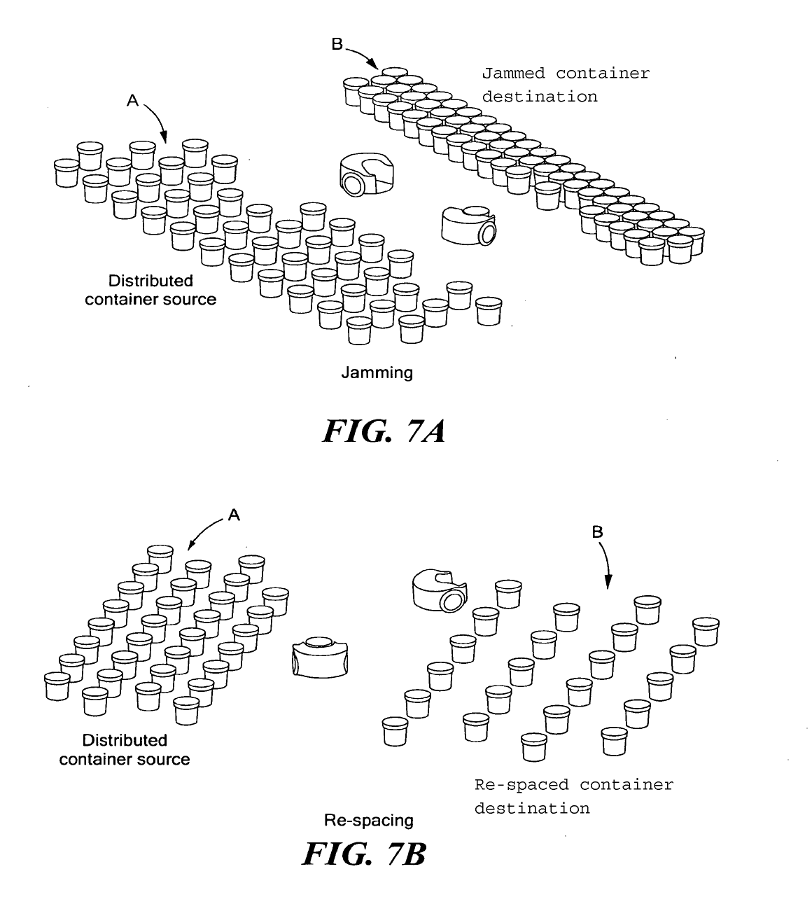

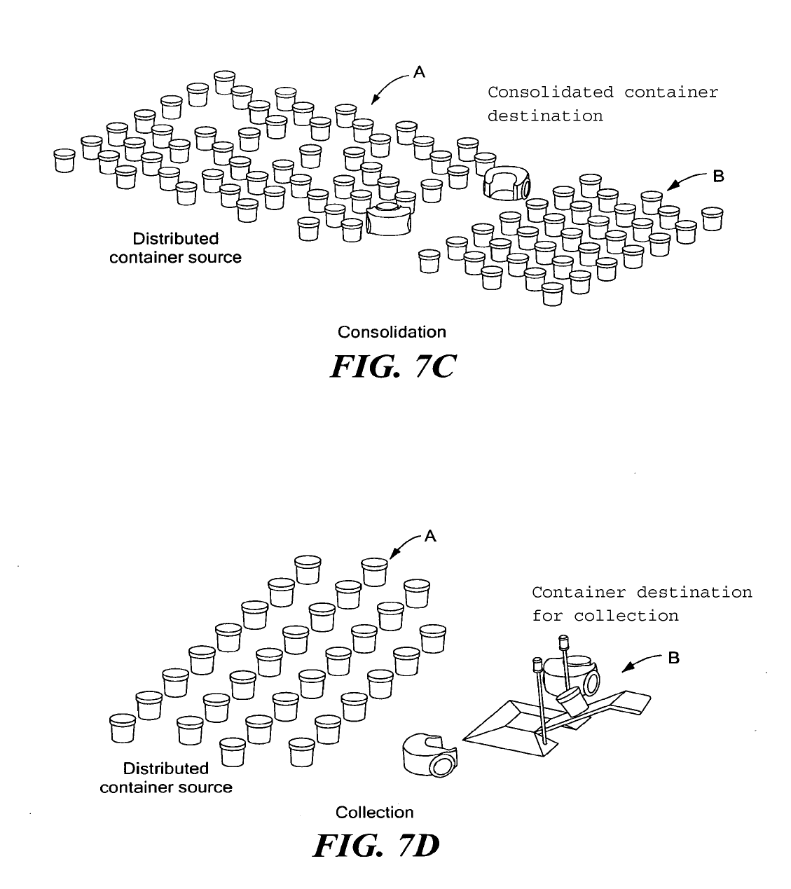

Similarly, distributed containers at source A, FIG. 7A, can be “jammed” at location B; distributed containers at location A, FIG. 7B can be re-spaced at location B; distributed containers at location A, FIG. 7C can be consolidated at location B; and/or distributed containers at location A, FIG. 7D can be transported to location B for collection.

Using multiple fairly inexpensive and simple robots, which operate reliably and continuously, large and even moderately sized growing operations can save money in labor costs.

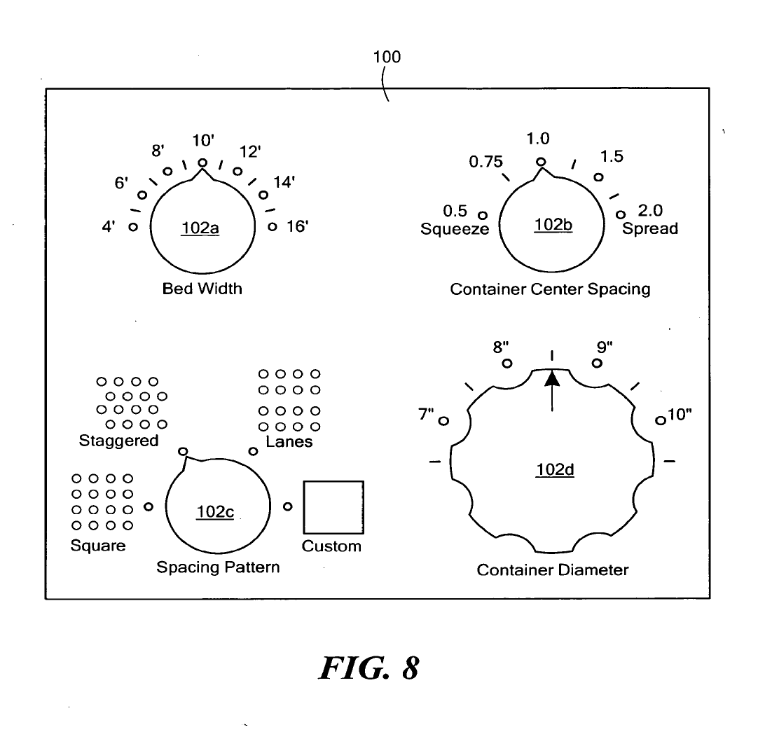

FIG. 8 shows an example of a robot user interface 100 with input 102a for setting the desired bed width. This sets a virtual boundary, for example, boundary 24c, FIG. 2. Input 102b allows the user to set the desired container spacing. Input 102c allows the user to set the desired spacing pattern. Input 102d allows the user to set the desired container diameter.

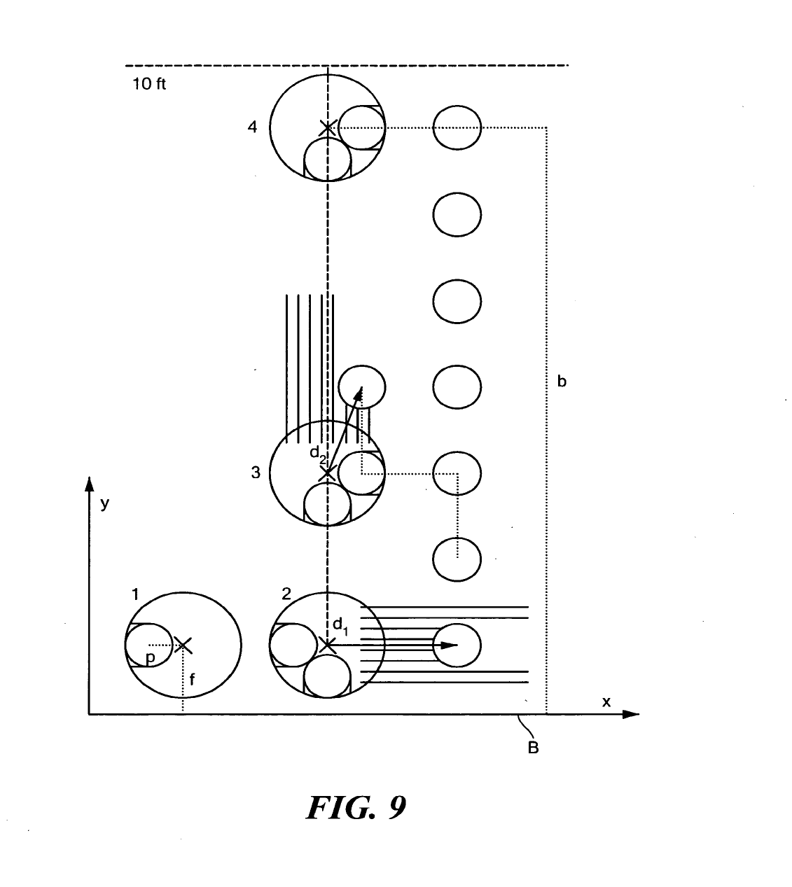

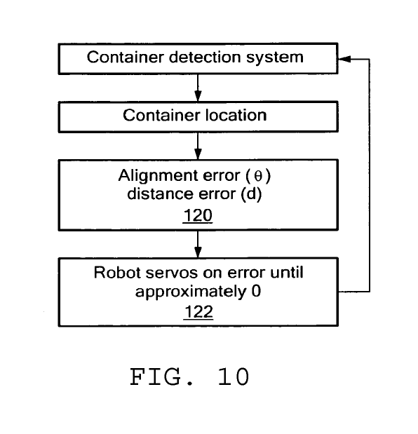

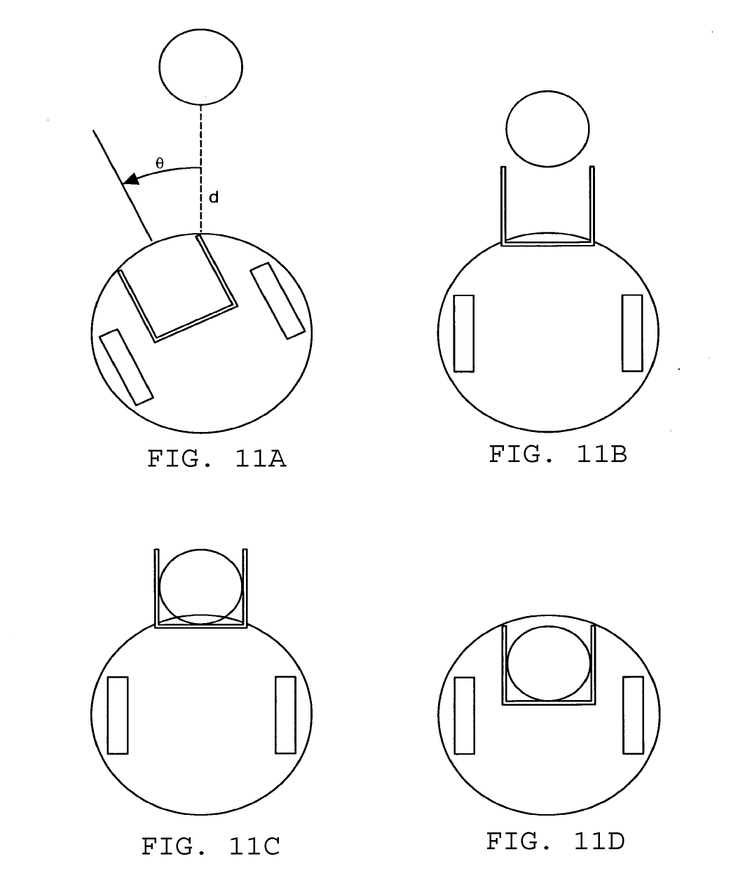

The general positioning of features on the robot are shown in FIG. 4 discussed above. The boundary sensor enables the robot to follow the reference boundary; the container sensors locate containers relative to the robot. The preferred container lifter is a one-degree-of-freedom mechanism including forks that remain approximately parallel with the ground as they swing in an arc to lift the container. Two drive wheels propel the robot. The robots perform the spacing task as shown in FIG. 9 in position 1, the robot follows the boundary B. At position 2, the robot's container sensor beams detect a container. This signifies that the robot must turn left so that it can place the container it carries in the adjacent row (indicated by the vertical dashed line). The robot typically travels along the dashed line using dead-reckoning. At position 3, the robot detects a container ahead. The robot computes and determines the proper placement position for the container it carries and maneuvers to deposit the container there. Had there been no container at position 3, the robot would have traveled to position 4 to place its container. The user typically dials in the maximum length, b, of a row. The computation of the optimal placement point for a container combines dead-reckoning with the robot's observation of the positions of the already-spaced containers. Side looking detectors may be used for this purpose.

The determination of the position of a container relative to the robot may be accomplished several ways including, e.g., using a camera-based container detection system.

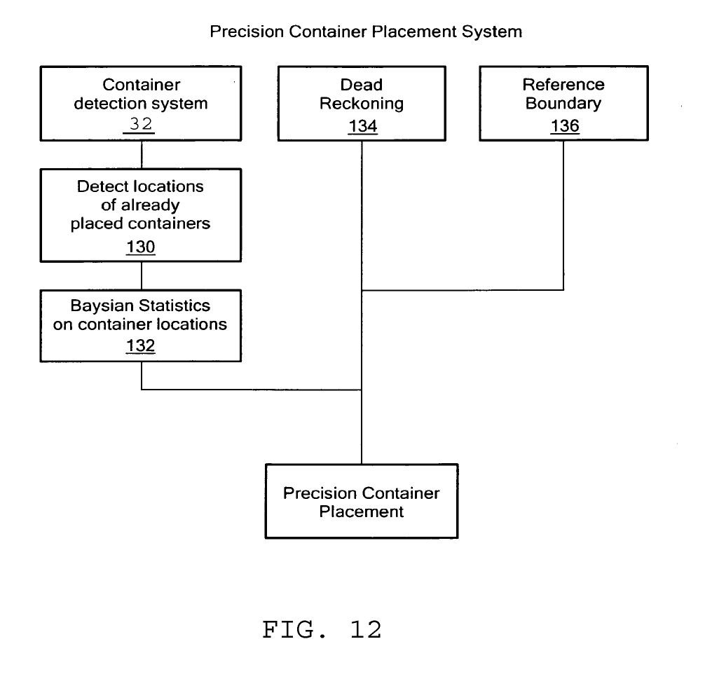

A flowchart of a container centering/pickup method is shown in FIG. 10. FIG. 11 depicts the steps the robot performs. In step 120, the robot servos to within a fixed distance d, FIG. 11A of the container with the forks retracted. The robot is accurately aligned for container pickup when angle θ is zero. In step 122, FIG. 10, the robot extends the forks and drives forward while serving to maintain alignment, FIG. 11B. In FIG. 11C, the robot detects the container between its forks and stops its forward motion. In FIG. 11D, the robot retracts the forks by sweeping through an arc. This motion captures the container and moves it within the footprint of the robot.

The preferred system in accordance with one or more embodiments generally minimizes cost by avoiding high-performance but expensive solutions in favor of lower cost systems that deliver only as much performance as required and only in the places that performance is necessary. Thus navigation and container placement are not typically enabled using, for example a carrier phase differential global positioning system. Instead, a combination of boundary following, beacon following, and dead-reckoning techniques are used. The boundary subsystem provides an indication for the robot regarding where to place containers, greatly simplifying the user interface.

The boundary provides a fixed reference and the robot can position itself with high accuracy with respect to the boundary. The robot places containers typically within a few feet of the boundary. This arrangement affords little opportunity for dead-reckoning errors to build up when the robot turns away from the boundary on the way to placing a container.

After the container is deposited, the robot returns to collect the next container. Containers are typically delivered to the field by the wagonload. By the time one wagonload has been spaced, the next will have been delivered further down the field. In order to indicate the next load, the user may position a beacon near that load. The robot follows this procedure: when no beacon is visible, the robot uses dead-reckoning to travel as nearly as possible to the place it last picked up a container. If it finds a container there, it collects and places the container in the usual way. If the robot can see the beacon, it moves toward the beacon until it encounters a nearby container. In this way, the robot is able to achieve the global goal of spacing all the containers in the field, using only local knowledge and sensing. Relying only on local sensing makes the system more robust and lower in cost.

Users direct the robot by setting up one or two boundary markers, positioning a beacon, and dialing in several values. No programming is needed. The boundary markers show the robots where containers are to be placed. The beacon shows the robots where to pick up the containers.

FIG. 12 depicts how, in one example, the combination of container detection system 32, the detection of already placed containers 130, the use of Bayesian statistics on container locations 132, dead reckoning 134, and boundary referencing 136 is used to precisely place containers carried by the robots.

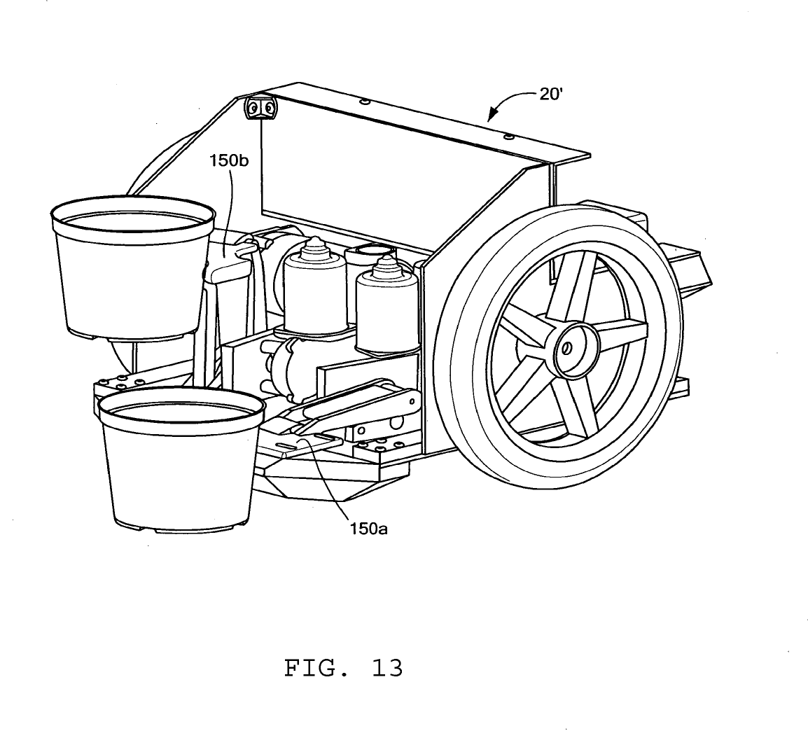

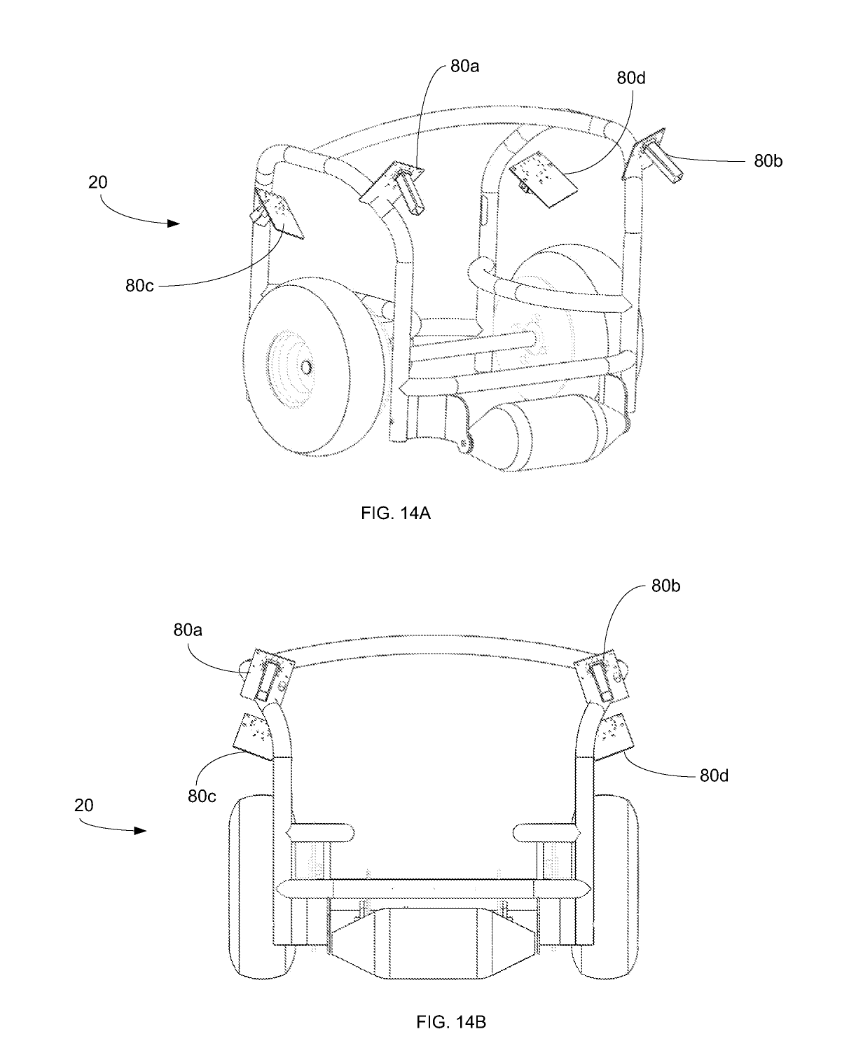

FIG. 13 shows a robot 20′ with dual container lifting mechanisms 150a and 150b in accordance with one or more further embodiments. In other embodiments, the lifting mechanism or mechanisms are configured to transport objects other than containers for plants, for example, pumpkins and the like.

Several engineering challenges present themselves in boundary detection and following by robots in an outdoor environment. It may be, at any given time, a sunny or cloudy day, dirt may be present on the boundary tape, shadows may be present (even shadows cast by the robot), and the like. Accordingly, in accordance with one or more embodiments, various techniques are provided to reduce adverse effects of outdoor deployment of the container handling robot.

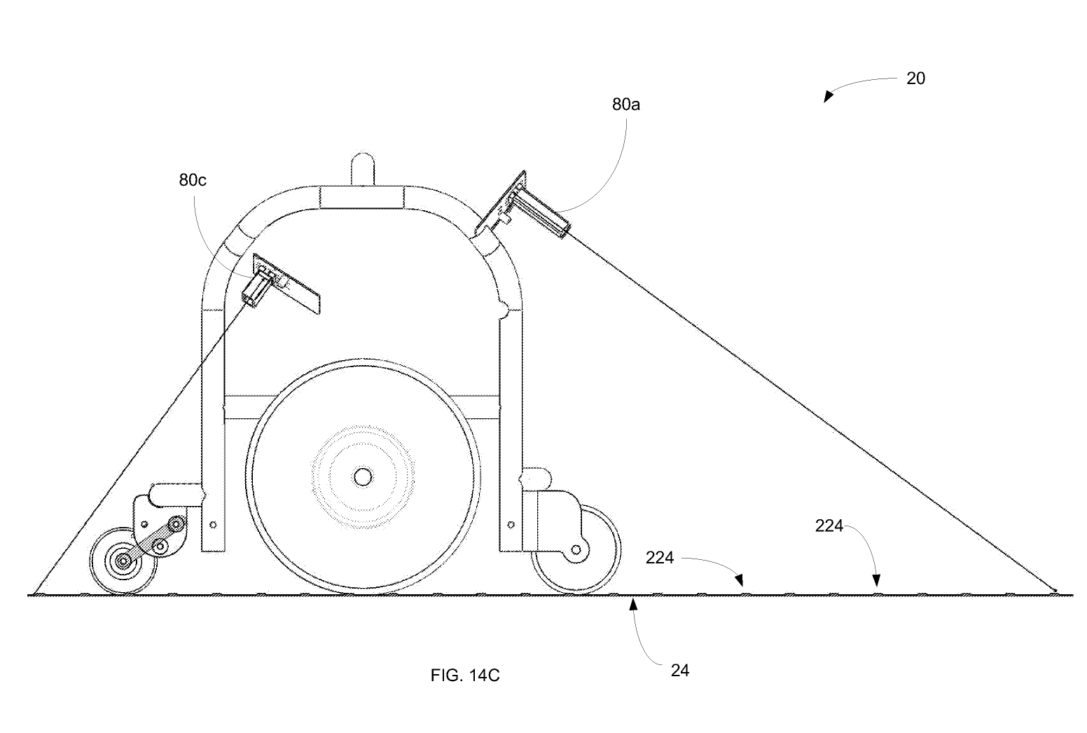

FIGS. 14A-C illustrate various views of a robot 20 with two front boundary sensing modules 80a and 80b and two rearward boundary sensing modules 80c and 80d. (Various other components of the robot have been omitted in FIGS. 14A-C for ease of illustration.) Removable retro-reflective tape 24 serving as a boundary marker is also shown in FIG. 14A. FIGS. 14A-C illustrate one exemplary orientation of these modules Other orientations are also possible.

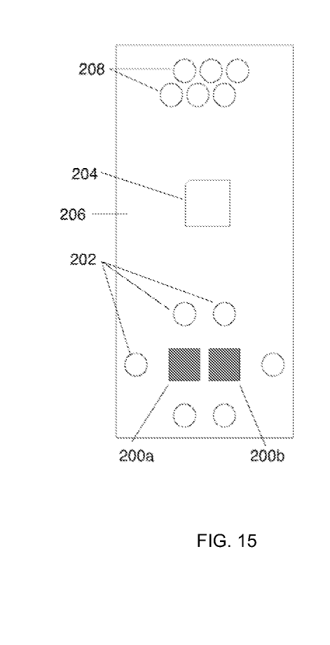

FIG. 15 illustrates various components of a boundary sensing module 80 in accordance with one or more embodiments including detectors (e.g., photodiodes) 200a and 200b and radiation sources (e.g., LEDs) 202 positioned in a generally circular pattern around detectors 200a and 200b on a circuit board 206. The boundary sensing module 80 also includes a microcontroller 204 which can, by way of example, be an NXP LPC 1765 microcontroller.

In accordance with one or more embodiments, to reduce the adverse effects of outdoor deployment, microprocessor 204, which is a component of the overall robot controller subsystem, may include a circuit or functionality configured to modulate LEDs 202. The LEDs are modulated so that the optical signal they produce can be detected under variable ambient light conditions often exasperated by robot movement and shadows. The modulation frequency can be generated using a pulse width modulation function implemented in microcontroller 204. The LEDs can be modulated at a 50% duty cycle. That is, for 50% of the modulation period, the LEDs emit light and for the other 50% they are off. If infrared emitters are used, a modulation frequency of between 10 to 90 kHz is sufficient.

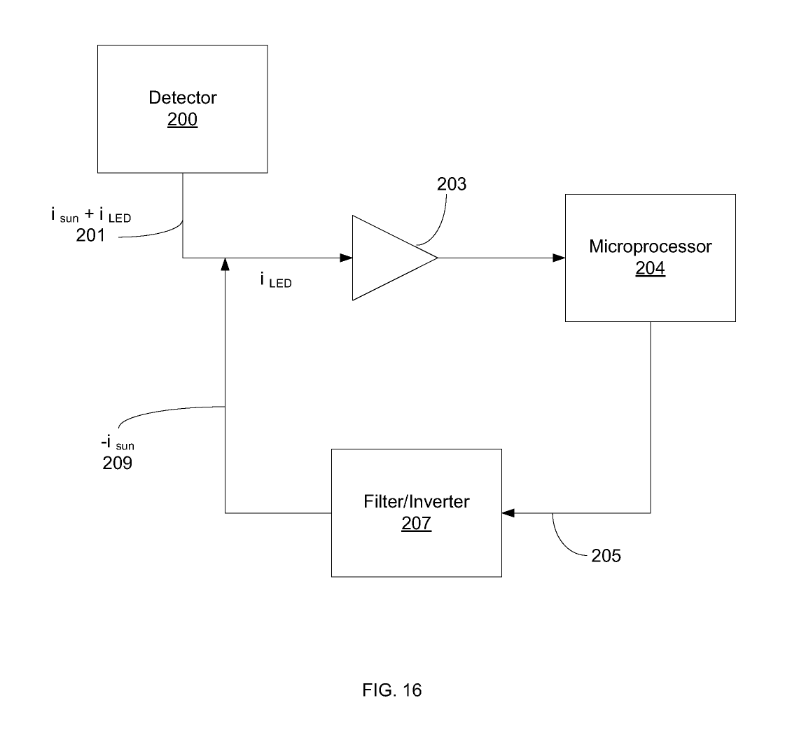

In accordance with one or more alternate embodiments, circuitry on circuit board 206 and/or functionality within microcontroller 204 may be configured to subtract or otherwise compensate for the detector current produced in response to sunlight from the overall detector signal. As shown in FIG. 16, detector 200 outputs a signal as shown at 201, which is the sum of the current output from the detector based on sunlight and light detected from the LEDs after being reflected off the retro-reflective boundary tape. This signal is amplified and/or converted to a digital signal at analog to digital converter 203 and then input to microcontroller 204. The same signal, however, as shown at 205 is presented to filter/inverter 207, which is configured to produce an output signal which is the opposite of the current component generated by sunlight detected by sensor 200 as shown at 209. Adding this signal to the combined signal output by detector 200 results in a subtraction of the detector current produced in response to sunlight from the detector signal.

The amplified photodiode signal 205 is passed through a low pass filter 207. In an exemplary implementation, the LEDs are modulated at 40 KHz and the low pass filter 207 has a corner frequency of 400 Hz (passes DC to 400 Hz, attenuates higher frequencies). This effectively eliminates the modulation signal and yields a signal that represents the background ambient light level (with frequencies below 400 Hz).

This ambient signal is converted to a current 209, which is the opposite polarity of the current generated in the photodiode due to ambient light. The two opposite currents cancel each other at the summing node, and the result is input to the photodiode amplifier 203.

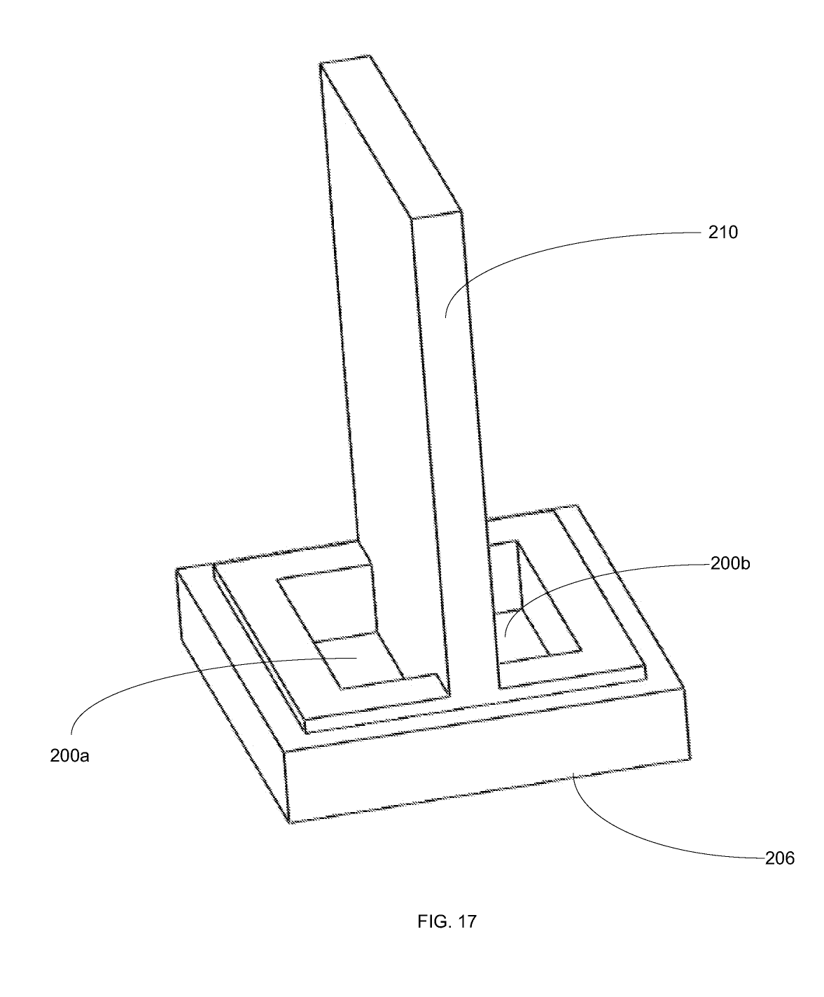

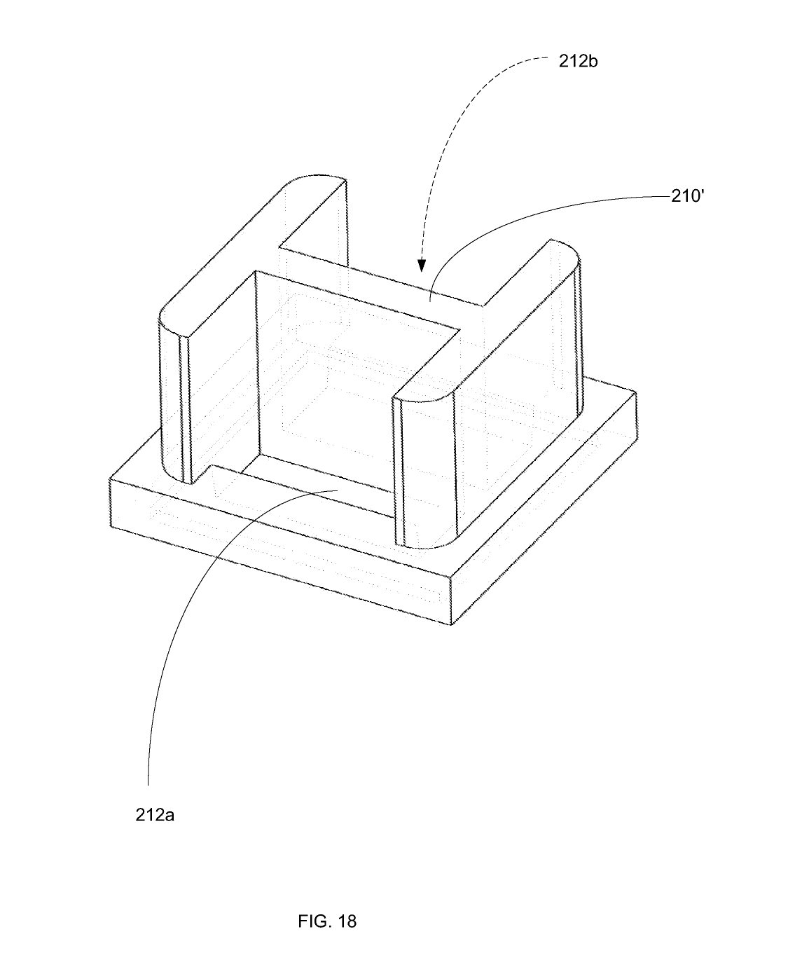

In accordance with one or more alternate embodiments, a shadow wall structure is provided in the boundary sensing module to reduce the adverse effects of outdoor deployment as illustrated by way of example in FIGS. 17 and 18. A shadow wall 210, FIG. 17 is advantageously disposed between detectors 200a and 200b as shown in order to better determine a position of a boundary marker relative to the sensing module. FIG. 18 shows another version of wall 210′ with channels 212a and 212b for detectors 200a and 200b, respectively.

A robust boundary follower can be constructed by using two photodiodes that are shadowed in a particular way using a shadow wall structure. The output of the system is the actual absolute displacement of the retro-reflective target from the center of the detector.

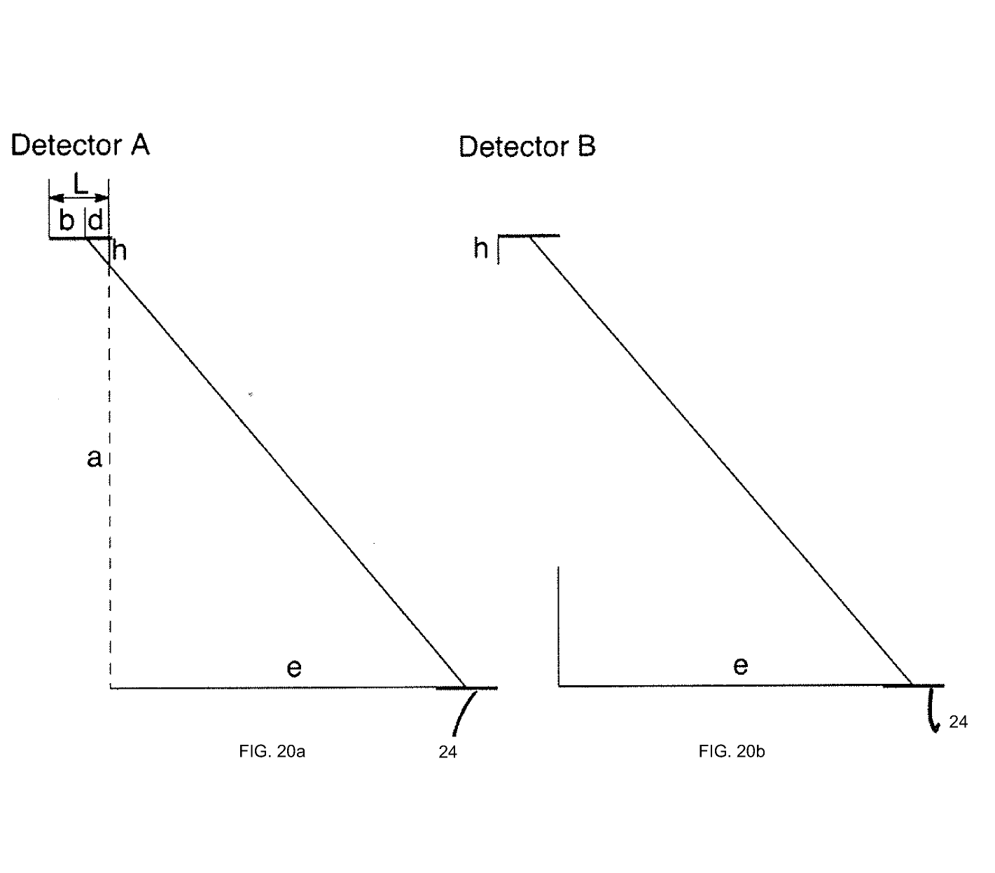

Referring to FIGS. 20a and 20b, consider Detectors A (200a) and B (200b) separated by a short shadow wall of height h. By way of example, the shadow wall height for the front sensors is about 7 cm, and about 3.5 cm for the rear sensors. The detectors are a distance a above the surface; retro-reflective material 24 is displaced a distance e from the edge of the detector. The wall, h, shadows a portion of the active material of Detector A when the target is to the right of the detector. A portion of Detector B is shadowed when the target is to the left. The target is approximated as if its cross section were a point.

Because detectors A and B are nearly co-located, were it not for the shadow wall, each detector would produce the same signal. However, because A is shadowed, it produces a smaller signal. Thus:

SA=kI*b/L (7)

and

SB=kI (8)

where I is the intensity of the light at the detector, k is a constant that accounts for detector gain, L is the width of the detector's active material, and b is the bright (not shadowed) portion of the detector. The shadowed part is d. As the target moves toward the center of the detector, b goes to L and the signals from the two detectors become equal.
From this geometry we see that L=b+d and that d/h=e/a. Substituting we get:

e=L(1−SA/SB)*a/h (9)

This is true as long as SA<SB. That condition holds when the target is to the right of the detectors. If SB<SA, then the target must be to the left of the detectors and an analogous computation can be done to determine e in that case.

Thus without a lens system, without correcting for range, and using direct ADC readings (for SA and SB), an accurate, absolute value for the position of the boundary relative to the sensor can be obtained.

Note that the robot can maintain a generally constant distance with only one boundary sensor (front or back). However, using both sensors, and maintaining a generally constant distance for both, will allow the robot to follow the boundary (and maintain proper heading) more accurately. (Depending on mountings the front and rear sensors may be calibrated differently, i.e., e=0, may be a different distance for front and rear sensors.)

A robot 20 can use the boundary sensor subsystem to orient and position itself, find and follow the edge(s) of the spacing area, and position containers with greater accuracy.

The boundary itself is preferably defined by a retro-reflective tape, rope, painted surface, or other element that is placed on the ground to run alongside the long edge of the active spacing area. Each robot has four very similar boundary sensors 80a, 80b, 80c, 80d positioned roughly at the four corners of the robot as shown in FIGS. 14A-14C.

The four sensors 80a, 80b, 80c, 80d can be mounted on the robot pointing outward and toward the ground as illustrated in the rear view of the robot shown in FIG. 14C, wherein each sensor has a field of view projected on the ground, a slight distance away from the robot.

Regardless of how they are used, the boundary sensors 80a, 80b, 80c, 80d in accordance with various embodiments have the ability to detect a relatively small target signal in bright sunlight. Each boundary sensor includes an array of infrared emitters 202 and one or more photodetectors 200a, 200b as shown in the exemplary circuit board of FIG. 15. In accordance with one or more embodiments, a signal is obtained by first turning on the emitters, then reading the detectors, then turning the emitters off, reading the detectors again, then subtracting. That is, the signals from each detector are:

S=Son−Soff (10)

The subtraction operation removes the ambient light from the signal leaving only the light reflected from the target. The intensity of this light is a function of distance by the inverse r-squared law, which however can be ignored for simplicity. Each sensor can therefore detect the boundary when a portion of the boundary lies within that sensor's field of view.

It should be noted that these fields of view are not completely discrete; the robot typically does not see perfectly within the field of view, nor is it completely blind to the boundary outside of the field of view.

After picking up a pot, the robot turns to face the boundary (based on its assumption about the correct heading to the boundary). The robot drives forward until it detects the boundary (which is also described herein as “seek” behavior), then uses boundary sensor data to position itself alongside the boundary (which is also described herein as “acquire” behavior). The front boundary sensors are used to detect and acquire the boundary.

When the Seek behavior is active, the robot moves in the (anticipated) direction of the boundary until it detects the boundary. As discussed above, in one or more embodiments, each sensor has two detectors 200a, 200b, with their signals being denoted SA and SB. When boundary material 24 comes within the field of view of the sensor and is illuminated by the emitters 202, the sum of the signals from each detector, SA and SB, increases. As the boundary approaches the center of the field of view, the sum of signals increases further. If the increase exceeds a threshold, the robot determines that it is within range of a boundary.

As the robot continues travelling forward with a boundary in the sensor's field of view, the boundary fills an increasing portion of the field of view. Then, as the field of view crosses the boundary, the boundary fills a decreasing portion. Thus, the sum of the detector signals first increases, then decreases. The peak in the signal corresponds to the boundary being centered in the field of view of the detector, allowing the robot to determine the robot's distance from the boundary. The robot might slow down to more precisely judge peak signals.

By measuring the distance to the boundary with both the left and right boundary sensors 80a, 80b, the robot can determine its angle with (i.e., orientation relative to) the boundary. This information can then be used to determine the best trajectory for the robot to follow in order to align itself parallel to the boundary. The robot can then align itself more precisely by using front and rear sensor data.

In one or more embodiments, in the Seek/Acquire behavior, the front boundary sensors 80a, 80b do not provide a general-purpose range sensor. They provide limited information that can be used to determine distance to the boundary. The following describes information the sensors provide the robot during Seek behavior.

Let RD represent the (on-the-ground) distance from the robot's center to the center of a front sensor field of view. Let F represent the radius of that field of view. During the Seek/Acquire behavior, each front sensor 80a, 80b can provide the following information to the robot: (a) If the sum of signals exceeds a threshold, the boundary is in the field of view. The robot knows its distance from the boundary is between (RD+F) and (RD−F); and (b) second, if the sum of signals peaks and starts to decrease, the boundary has just crossed the center of the sensor's field of view. The robot knows its distance has just passed RD. By comparing the distances from the two sensors 80a, 80b, the robot can tell its approach angle.

Alternatively, if one front sensor crosses the boundary, and too much time elapses without the other front sensor detecting the boundary. The robot can infer that its approach angle is very shallow.

Ideally, the front sensors 80a, 80b would look very far in front of the robot to give the robot space to react at high speeds. However, the distance the boundary sensor can look forward is geometrically limited by the maximum angle at which retro-reflection from the boundary marker is reliable (typically about 30°) and the maximum height at which the boundary sensor can be mounted on the robot. The sensor mountings are designed to balance range and height limitations, resulting in a preferred range requirement wherein the front sensors are able to detect boundary distance at a minimum range of about 750 mm in one example.

Boundary sensor mountings may be adjusted to improve performance, so the range could potentially increase or decrease slightly. Additionally, adjustment could also be made to cope with undulations in the ground.

The fore/aft field of view of the boundary sensor should be sufficiently large that, as the robot approaches the boundary at a maximum approach speed during Seek behavior, the boundary will be seen multiple times (i.e., over multiple CPU cycles of the microcontroller 204) within the field of view. In one example, if the robot travels at 2 m/s and the update rate is 400 Hz, then the robot travels 2/400=0.005 m or 5 mm between updates. Assuming that 5 update cycles are sufficient for detection, a minimum field of view of 25 mm should suffice. The front sensors' field of view preferably has a minimum fore/aft length (robot X length) of 25 mm (i.e., center±12.5 mm).

After the robot has acquired the boundary, the Follow Boundary behavior will become active. In Follow Boundary behavior, the front sensors should overlap the boundary.

While the robot moves to acquire the boundary, it will continue sensing. (It does not need to plan a perfect blind trajectory based on the data it obtains during Seek behavior.) As a result, the robot is fairly tolerant to errors in distance. As long as it detects the boundary during Seek behavior, it knows it is roughly within its field of view, which will enable it to begin to turn. As it turns, it continues to receive data from the front boundary sensors 80a, 80b. If the front sensors' field of view crosses the boundary too quickly, the robot can adjust its perceived position. The front sensors 80a, 80b should consistently detect the boundary at a consistent point within their field of view, ±38 mm in one example.

A robot can also use the difference between the two sensors 80a, 80b to compute its angle of approach. The robot, in one example, can reliably Acquire the boundary if it can detect its approach within ±10 degrees. Assume the robot approaches the boundary at an angle A. w is the distance between the two fields of view, and T is the distance the robot will have to travel before the second sensor detects the boundary.

$$\begin{matrix}tan A = \frac{w}{T} and & ( 11 ) \\ T = \frac{w}{tan A} & ( 12 )\end{matrix}$$

To ensure that the robot's reported angle is within 10 degrees of the actual angle A, the robot should know T within some range±X.

It can be assumed that the robot must be approaching at an angle somewhat close to perpendicular (or the robot's search will time out before the second sensor detects the boundary). Assume, for example, the robot is within 30° of perpendicular. Given, in one example, that w=748 mm and A=60°, we can compute T=431 mm, then:

$$\begin{matrix}tan ( A + 10 ° ) = \frac{w}{( T + x )} and & ( 13 ) \\ tan ( 70 ° ) = \frac{748}{( 431 + x )} & ( 14 )\end{matrix}$$

Solving for x we get x=−159 mm.

So, if the robot approaches the boundary at an angle, e.g., within 30° of perpendicular, and wants to detect its heading within 10°, the second sensor should detect the boundary within an accuracy of about 160 mm. This is much more forgiving than the 38 mm example noted above, so heading does not impose any additional constraints. (Likewise, at a 60° approach, solving for A—10° is also more forgiving.)

Note that the distance sensitivities become higher when the robot approaches closer to perpendicular. Even at 88°, however, the robot must only detect the accuracy within about 130 mm—which is still much less stringent than the 38 mm example above. Also, the worst case has the first sensor detecting as soon as possible, and the second sensor detecting as late as possible. So in practice in some embodiments it is possible to cut the distances in half. But this is likely to be rare—and even so, the accuracy requirements are still less stringent than the 38 mm example above.

The Follow Boundary behavior becomes active once the robot is positioned generally parallel to the boundary with the intent to travel along it. The robot servos along the boundary and attempts to maintain a constant distance.

The robot uses two side boundary sensors (front and rear) to follow the boundary. (It is possible to perform this function less accurately with only one sensor.) Each sensor reports an error signal that indicates the horizontal distance from the boundary to the center of its field of view (or some other point determined by bias).

When the robot is following the boundary, there are preferably a few inches between the wheel and the boundary tape (e.g., 3″ or 76 mm) when the boundary tape is centered in the sensors' lateral field of view. The sensor mountings are designed to balance range and height limitations. The mountings are the same for Seek/Acquire and Follow behavior, so the range values are the same as well.

The width of the boundary sensor field of view (i.e., diameter in robot Y) comprises the range over which the robot can servo on the boundary marker during Follow behavior. In one example, this number is on the order of 7 inches (178 mm). To support boundary following, the front sensors' left/right field of view (robot Y width) are preferably at least 157 mm wide in one example.

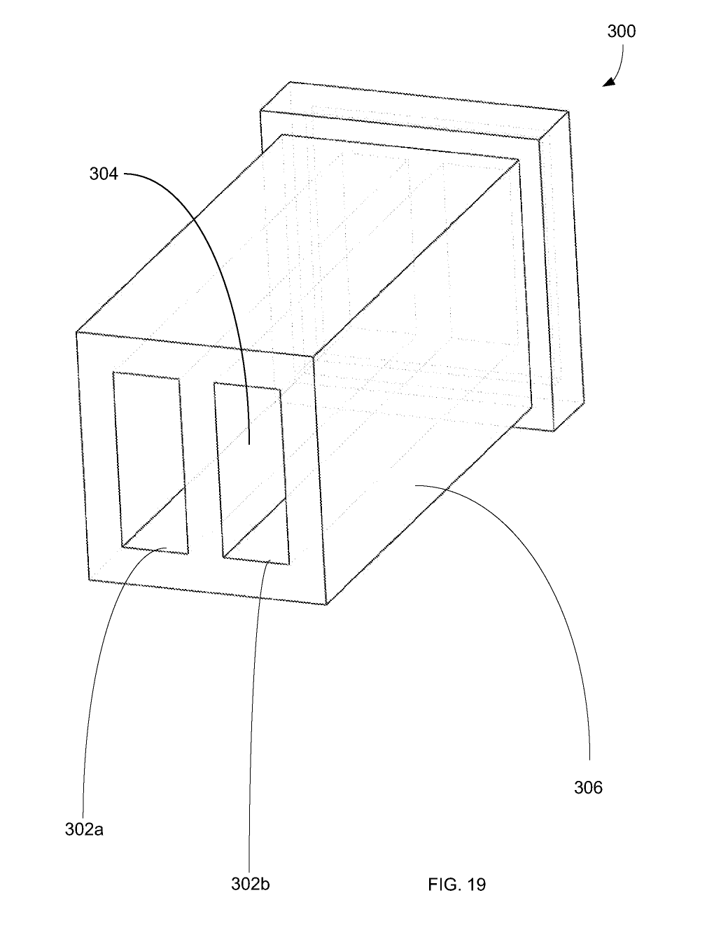

The illuminated patch on the ground visible to the robot is a conic section, and the patch is longer in the fore/aft direction of the robot than it is transverse to the robot. This results in a condition where a larger section of retro-reflective boundary is illuminated (and visible) and the signal strength during follow behavior may be substantially higher than during seek behavior. This effect may result in less than desirable signal levels during seek behavior, or, alternatively, may cause saturation during follow behavior. In accordance with one or more embodiments, the effect can be mitigated through a brute force solution using an A/D converter with higher dynamic range. Alternately, in accordance with one or more further embodiments, the effect can be mitigated using a mask structure 300 placed over the detectors 200a and 200b to equalize the fore/aft and lateral field views as illustrated in the example of FIG. 19. The mask structure 300 includes two openings 302a, 302b separated by a center wall 304, each leading to one of the detectors 200a, 200b. The mask structure 300 includes outer sidewalls 306 that are closed to reduce the effect of background light on detector readings and improve the system's signal to noise ratio. In combination with the mask openings discussed above, the closed side walls can greatly improve the efficiency of the system.

Similarly, it can be noted that, particularly for the forward facing boundary detectors, the desired size of the illuminated area on the ground visible to the robot is small relative to the distance between the light source and the illuminated area. In accordance with one or more embodiments, in the interest of minimizing power consumption, the emission angle of the light source should be matched to the geometry of the system. The emission angle can be controlled thru optical means such as a collimating lens, or thru the use of extremely narrow beam LEDs (e.g., OSRAM LED part number SFH4550 (+/−3 degrees)).

In one example, the front sensors have a 770 mm range to the ground, and the rear sensors have a 405 mm range—so the rear sensor field of view can be proportionately smaller. The rear sensors' left/right field of view (robot Y width) in this example should be at least 113 mm wide.

Localization refers to the process of tracking and reporting the robot's absolute position and heading. In accordance with one or more embodiments, the robot's controller 34 executes Localizer software for performing these functions. There are a number of inputs to the robot's Localizer software. These can include dead reckoning, gyro input, and the like, but the boundary is preferably the only absolute position reference. It forms the spacing area's Y axis. In one example, the boundary is a primary input to localization. It is used in several ways and it provides an absolute Y position reference (denotes Y=0), and it provides an absolute heading reference. The robot can derive its angle to the boundary by looking at the difference between the two front sensor distances during Seek/Acquire behavior, or between the front and back sensor distances during Follow behavior. Since the boundary forms the absolute Y axis, the robot can derive its absolute Y heading from its angle to the boundary.

In accordance with one or more embodiments, the boundary can include tick marks to provide an absolute indicator for where container rows may be placed. As discussed above, the boundary can be defined by a retro-reflective tape 24 (FIG. 14C), which can include periodic tick marks 224 along the length of the tape comprising non-reflective portions.

The retro-reflective tape with tick marks can be formed in various ways. In accordance with one or more embodiments, the non-reflective portions of the tape defining the tick marks 224 can comprise a non-reflective tape, paint, or other material selectively covering the retro-reflective tape 24. In one or more alternate embodiments, the retro-reflective tape 24 is formed to have an absence of reflective material in the locations of the tick marks.

The tick marks on the boundary can be used to judge distance traveled. The robot knows the width of each tick mark, and it can determine the number of ticks it has passed. Thus, the robot can determine and adjust its X position as it moves, by multiplying the number of ticks passed by the tick width. This can allow the robot to more accurately track its absolute X position.

Boundary sensor data is used for localization while executing Boundary Follow behavior. While the Boundary Follow behavior is active, the robot servos along the boundary. Thus, if the robot is following accurately, it knows its distance (i.e., the constant servo distance) and heading (i.e., parallel to the boundary).

The robot should know its Y (absolute) position relative to the boundary with good accuracy, which in some examples can be on the order of a millimeter. Sensor signal strength and accuracy are likely to be affected by environmental conditions like temperature, crooked boundaries, etc.

The robot can determine the position and orientation of the boundary by various techniques, including, e.g., integration or using a Kalman filter as it moves along the boundary. This somewhat relaxes the single-measurement accuracy requirement of the sensor.

In accordance with one or more embodiments, the robot can use boundary sensor data to compute two kinds of localization data: Y offset (distance to boundary) and heading (with respect to boundary). Accuracy requirements can be expressed in terms of overall robot performance (computed over multiple measurements and while executing behaviors) and in terms of sensor performance.

Over 1 meter of travel, the robot's measured Y offset from the boundary is preferably accurate within ±0.25 inches in one example. (This is determined by the accuracy requirements of pot spacing.) In order to space pots in rows that “appear straight,” pots should be placed along rows±1.5 inches, or about 38 mm in one example.

In one example, using the trigonometry, we can compute that for the pot furthest from the boundary (12′), to achieve error e of ±1.5 inches, the boundary angle error θ should be within approximately 0.60 degrees.

Over 1 meter of travel, the robot's measured angle from the boundary should be accurate within ±0.60 degrees in one example. In one example, individual sensors can provide error offset (as in Follow Boundary) resolution of ±1 mm.

Retro-reflectivity enables the robot to discriminate between the boundary marker and other reflective features in the environment. Typically, the retro-reflective marker will be the brightest object in the sensor's field of view. If this is true then a simple threshold test applied to the return signal strength is sufficient to eliminate false targets. However, bright features (or tall features not on the ground) could result in false boundary detections. In accordance with one or more embodiments, a simple addition to the detector board can improve performance in these cases. In FIG. 15 exemplary circuit board of the boundary sensing module, the LEDs, 202, are placed very near the detectors 200a, 200b. This arrangement is used because the retro-reflective material of the boundary marker sends radiation that reaches it back toward the source (within a small angle). This property can advantageously be used to discriminate between retro-reflective and bright but non-retro-reflective objects. This is accomplished in accordance with one or more embodiments by placing on the board an additional IR source 208 of the same power as the existing LEDs 202, but removed some distance from the detectors 200a, 200b. By alternating activation of the near and far LEDs, it can be determined whether a strong reflection comes from a bright feature or from the retro-reflective boundary. If the signal detected when the far LEDs are on is approximately equal to the signal when the near LEDs are on, then the reflection likely comes from a bright diffuse source. When the response to the near LEDs is significantly stronger than the far LEDs, there is a strong likelihood that retro-reflection is being sensed.

As previously discussed, the boundary tape may have a periodic pattern of reflective and non-reflective material. These alternating sections will encode absolute reference points along the boundary. The non-reflective sections are referred to as “tick bars,” and the reference points are referred to as “tick marks.” During spacing, the robot can use these tick marks to more accurately determine its absolute X position. This can serve the following purposes. The tick marks help determine the legal X position of rows of containers. This enables the system to avoid an accumulation of spacing error in the global X dimension. Accumulated spacing error might (a) challenge the system's ability to meet field efficiency (space utilization) requirements, and (b) make spaced pots appear irregular and inaccurate. In accordance with one or more embodiments, for teaming, each robot will broadcast its global X and Y coordinates. This requires a common coordinate reference. Because the tick sections repeat, the tick mark scheme does not provide a truly global X reference. But the sections will be large enough that this is not likely to be a problem. The robots would know their position within a section, so would able to avoid collisions. For example, suppose that we encode the tick marks such that the pattern repeats every 100 feet. This means that every tick mark within a 100-foot section is unique but across sections they are not unique. Thus it might be possible for a first robot to believe that it is operating near a second robot when in fact the second robot is actually operating in a different 100-foot section. This will be rare in practice.

In accordance with one or more embodiments, the boundary tape can contain a series of repeating sections of regular length. Each section will be longer than the distance the robot will typically drive from source to destination, e.g., 20 meters. Each section will have the same pattern of tick bars. The relative width and pattern of the bars encodes a series of numbers indicating absolute ‘tick mark’ positions within each section.

In accordance with one or more embodiments, the robot's front sensors' field of view is longer along the front/aft (robot X dimension) axis than that of the rear sensors. The front sensors' field of view is longer than the non-reflective sections are wide. As a result, the front sensors can disregard the non-reflective bars. The tick marks will make the front sensors' signal strength both weaker and more variable. The rear sensors can include a lens or collimating element that will make their field of view shorter along the front/aft (robot X dimension) axis—i.e., they cease to detect the boundary when the robot passes a non-reflective bar. However, their field of view will still be wide enough along the left/right (robot Y dimension) axis to meet the Boundary Follow behavior requirements described above.

In accordance with one or more embodiments, the rear sensors' sampling rate is high enough that the sensor signal will alternate on/off as the robot moves along the boundary. The robot can use its expected velocity and sensor data across time to compute the length of the non-reflective bars as it passes them. It can thus read the code to determine its absolute tick mark position within the section.

Pots are placed only at legal points along the boundary. In one or more embodiments, there is always a legal row at every code-repeat point (i.e., beginning of a tick section). There are other legal rows between code repeat points, referenced to positions indicated by tick marks.

When the robot is given the user-specified spacing width, it can compute the number of rows that must fit within a section (i.e., between two code-repeat points). The robot can also compute the legal X position (starting place) of every row along the boundary, relative to the tick mark positions. Note that the legal row locations do not necessarily line up with the tick mark positions. This absolute reference eliminates error in the number of rows the robot will place within a given area.

In accordance with one or more embodiments, because a row always starts at the beginning of a section (code-repeat point), the pots are not necessarily placed at exactly the user-specified width. The actual spacing width may be rounded slightly to ensure that the code-repeat point is at a legal row. But because each section is relatively long relative to the spacing width, this difference is not significant.

More specifically, ifs is the width of each section, n is number of tick marks per section, w is spacing width (as determined by user setting), q is the number of pots actually fitted within a section=floor(s/w) and xt is the robot's X location (absolute within the repeating section, not absolute within the spacing area), as decoded from tick marks, then each legal row will occur where:

xt=k(n/q) where k=(0, . . . , q−1) (15)

When placing a pot, the robot preferably ensures that the pot is placed in a legal row, i.e., where this condition is true.

The front sensors 80a, 80b should be able to detect any portion of the boundary at least as long as the smallest diameter (currently width) of the front sensor field of view. The tick marks may reduce the front sensors' signal strength. But even when the field of view covers the most non-reflective possible portion of the boundary, the sensors should still produce a signal strong enough to detect—and robust enough for the robot to reliably detect the signal's peak. The front sensors 80a, 80b should be able to see the boundary and effectively ignore the tick marks during both Seek and Follow behavior. As a result, the width and length of the front sensors' field of view should be larger than, e.g., at least several times, the width of the widest tick mark bar.

Likewise, in order to see ticks, the fore/aft field of view of the rear sensors should be less than the width of the narrowest bar on the boundary marker.

A maximum emitter response can be achieved using a pristine boundary tape, under bright ambient light conditions, at full range. The reading without the boundary tape, on a worst-case surface (perhaps clean ground cloth) should be significantly lower. The sensors should be able to detect reflected LED emitter light while compensating for ambient light. Emitter strength should be set properly to achieve that across a range of ambient lighting conditions. The sensors should be able to achieve the specified accuracy under a range of non-changing or slowly varying lighting conditions. These include full sunlight, darkness, and shade.

In accordance with one or more embodiments, the sensors should be insensitive to changes in varying ambient light levels as the robot moves at its maximum velocity. These include the conditions noted above. For example, the sensor should respond robustly even while the robot moves from full shade to full sunlight. It is assumed that the frequency at which the ambient light varies will be relatively low (below 400 Hz) even when the robot is in motion. The most dramatic disruptive pattern that would be sustained in the environment over many samples could be a snow fence, e.g., with 2.5 mm slats spaced 2.5 mm apart. Assuming the robot travels at a maximum of 2 m/s, a shadow caused by this fence would result in a 400 Hz ambient light signal. The robot should preferably be able to compensate for such a signal.

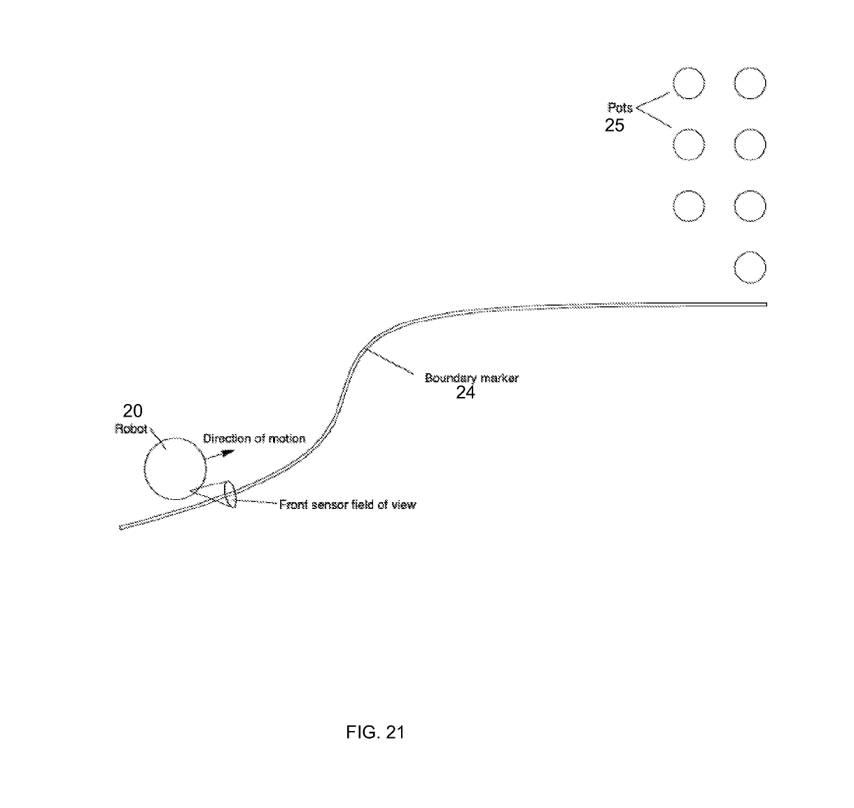

Robots in accordance with various embodiments can be configured to follow both straight and irregular boundary markers. As shown in FIG. 21, a robot 20 follows a curved boundary marker 24. Being able to follow curved boundary markers increases the versatility of the robots. For example, this allows robots to pickup pots 25 from an area outside the bed, carry pots 25 to the bed, and space them on the bed. The feature also enables the construction of transport robots that simply follow a boundary marker of arbitrary shape from one point to another.

Having thus described several illustrative embodiments, it is to be appreciated that various alterations, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments. Additionally, elements and components described herein may be further divided into additional components or joined together to form fewer components for performing the same functions.

Accordingly, the foregoing description and attached drawings are by way of example only, and are not intended to be limiting.

What is claimed is:

1. An adaptable container handling robot comprising:
a chassis;
a container transport mechanism;
a drive subsystem for maneuvering the chassis;
a boundary sensing subsystem configured to reduce adverse effects of outdoor deployment; and
a controller subsystem responsive to the boundary sensing subsystem and configured to:
detect a boundary,
control the drive subsystem to turn in a given direction to align the robot with the boundary, and
control the drive subsystem to follow the boundary.

2. The robot of claim 1 wherein the boundary comprises a retro-reflective element.

3. The robot of claim 2 wherein the retro-reflective element comprises a tape, a rope, or a painted surface.

4. The robot of claim 1 wherein said boundary sensing subsystem includes at least one boundary sensing module including at least one source of radiation and at least one radiation detector for detecting radiation reflected by the boundary from the at least one source of radiation.

5. The robot of claim 4 wherein said boundary sensing subsystem includes a circuit configured to modulate the source of radiation.

6. The robot of claim 4 wherein said boundary sensing subsystem includes a circuit responsive to a signal output by the detector and configured to subtract detector current produced in response to sunlight from the detector signal.

7. The robot of claim 4 wherein said boundary sensing module includes two detectors and a shadow wall between the two detectors for shadowing one of the detectors to reduce its output signal relative to the other detector and wherein the controller subsystem is configured to detect the boundary based on the detector output signals.

8. The robot of claim 4 wherein said boundary sensing subsystem includes a circuit responsive to a signal output by the detector and configured to turn on the source, read the detector signal, turn off the source, read the detector signal, and subtract the two readings to remove ambient light from the detector signal.

9. The robot of claim 4 wherein said boundary sensing subsystem further comprises a mask structure positioned in front of the two detectors, said mask structure including two openings leading to the detectors to generally equalize fore/aft and lateral field views of the detectors.

10. The robot of claim 9 wherein the mask structure includes outer sidewalls and a center wall defining separate passages leading to each of the detectors from the openings.

11. The robot of claim 1 wherein said boundary comprises a retro-reflective element, and wherein said boundary sensing subsystem includes at least one boundary sensing module including first and second sources of radiation and a radiation detector, wherein said first source of radiation is located closer to the radiation detector than the second source of radiation, and wherein the first and second sources of radiation are alternately activated and the controller subsystem is configured to determine that the retro-reflective element is being sensed when a reflected signal detected by the radiation detector from the first radiation source is stronger than a reflected signal detected from the second radiation source.

12. The robot of claim 1 wherein the controller subsystem is further configured to calculate an angle of travel for the robot with respect to the boundary.

13. The robot of claim 12 wherein the controller subsystem is further configured to calculate an angle to turn the robot in order to follow the boundary.

14. The robot of claim 12 wherein the boundary sensing subsystem includes two front sensors and two rear sensors, and wherein the controller subsystem is configured to determine an angle of travel of the robot relative to the boundary based on the difference between the calculated distances from the two front sensors to the boundary during seek behavior or based on the difference between the calculated distances from a front sensor to the boundary and a back sensor to the boundary during follow behavior.

15. The robot of claim 1 wherein the controller subsystem is configured to track the robot's position and orientation using the boundary as a reference.

16. The robot of claim 1 wherein the boundary includes a periodic pattern of reflective and non-reflective areas along the length thereof to enable the robot to judge distance traveled.

17. A method of operating an adaptable container handling robot in an outdoor environment, comprising the steps of:
providing a boundary outside on the ground;
maneuvering a robot equipped with a boundary sensing subsystem to:
detect the boundary,
turn in a given direction to align the robot with the boundary, and
follow the boundary; and
reducing adverse effects of outdoor boundary sensing and following.

18. The method of claim 17 wherein reducing adverse effects includes using retro-reflective material as the boundary.

19. The method of claim 17 wherein detecting the boundary includes irradiating the boundary using a radiation source and detecting light reflected off the boundary using a detector.

20. The method of claim 19 wherein reducing adverse effects of outdoor boundary sensing and following includes modulating the radiation source

21. The method of claim 19 wherein reducing adverse effects of outdoor boundary sensing and following includes subtracting detector current produced in response to sunlight from a signal output by the detector.

22. The method of claim 19 wherein detecting includes using two radiation detectors and reducing the adverse effects of outdoor boundary sensing and following includes shadowing one of the two detectors to reduce its output signal relative to the other detector and detecting the boundary based on the detector output signals.

23. The method of claim 19 wherein reducing adverse effects of boundary sensing and following includes turning on the radiation source, reading the detector signal, turning off the radiation source, reading the detector signal, and subtracting the two readings to remove ambient light from the detector signal.

24. The method of claim 17 wherein turning in the direction of the boundary includes calculating an angle of travel of the robot with respect to the boundary.

25. The method of claim 17 wherein turning in the direction of the boundary includes calculating an angle to turn the robot in order to follow the boundary.

26. The method of claim 17 wherein detecting includes using two radiation detectors and reducing the adverse effects of outdoor boundary sensing and following includes masking the detectors to generally equalize fore/aft and lateral field views of the detectors.

27. The method of claim 17 wherein detecting includes using first and second sources of radiation and a radiation detector, wherein said first source of radiation is located closer to the radiation detector than the second source of radiation, and wherein reducing the adverse effects of outdoor boundary sensing and following includes alternately activating the first and second sources of radiation and determining that the retro-reflective element is being sensed when a reflected signal detected by the radiation detector from the first radiation source is stronger than a reflected signal detected from the second radiation source.

28. The method of claim 17 wherein detecting includes using two front sensors and two rear sensors, and further comprising determining an angle of travel of the robot relative to the boundary based on the difference between the calculated distances from the two front sensors to the boundary during seek behavior or based on the difference between the calculated distances from a front sensor to the boundary and a back sensor to the boundary during follow behavior.

29. An adaptable container handling robot movable on a ground surface having a boundary including a pattern of tick marks, the robot comprising:
a chassis;
a container transport mechanism;
a drive subsystem for maneuvering the chassis;
a boundary sensing subsystem; and
a controller subsystem responsive to the boundary sensing subsystem and configured to detect and follow the boundary and to detect the pattern of tick marks while following the boundary to establish one or more reference points on the ground surface.

30. The robot of claim 29, wherein the one or more reference points specify a position of the robot on the ground surface.

31. The robot of claim 30, wherein the controller subsystem is further configured to broadcast the position of the robot to other robots in a given area to avoid collisions between robots.

32. The robot of claim 29, wherein the boundary sensing subsystem comprises one or more radiation sources and detectors, wherein the boundary comprises a retro-reflective material, and wherein the tick marks comprise non-reflective elements fixed on the retro-reflective material.

33. The robot of claim 29, wherein the controller subsystem is further configured to determine a distance traveled along the boundary by counting the number of tick marks passed by the robot.

34. A robot of claim 29, wherein the controller subsystem is further configured to determine container placement locations based on the reference points.

35. A method of operating a robot equipped with a boundary sensing subsystem, comprising the steps of:
providing a boundary on a ground surface, said boundary including a pattern of tick marks; and
maneuvering the robot to detect and follow the boundary and to detect the pattern of tick marks while following the boundary to establish one or more reference points on the ground surface.

36. The method of claim 35, wherein the one or more reference points specify a position of the robot on the ground surface.

37. The method of claim 36, further comprising broadcasting the position of the robot to other robots in a given area to avoid collisions between robots.

38. The method of claim 35, wherein the boundary sensing subsystem comprises one or more radiation sources and detectors, wherein the boundary comprises a retro-reflective material, and wherein the tick marks comprise non-reflective elements fixed on the retro-reflective material.

39. The method of claim 35, further comprising determining a distance traveled along the boundary by counting the number of tick marks passed by the robot.

40. A method of claim 35, further comprising determining container placement locations based on the reference points.
